(19) United States
(12) Patent Application Publication
(10) Pub. No.: US 2024/0029909 A1
(43) Pub. Date: Jan. 25, 2024

(54) METHOD FOR PRODUCING HIGH PURITY AND HIGH SPECIFIC ACTIVITY RADIONUCLIDES

(71) Applicants: ADVANCED ACCELERATOR APPLICATIONS, Saint-Genis-Pouilly (FR); ARONNAX, Saint-Herblain (FR); ORGANISATION EUROPEENNE POUR LA RECHERCHE NUCLEAIRE, Geneve (CH)

(72) Inventors: Roberto FORMENTO CAVAIER, POZZILLI(Isernia) (IT); Ilyes ZAHI, Saint-Genis-Pouilly (FR); Ferid HADDAD, Saint-Herblain (FR); Thierry STORA, Meyrin (CH)

(21) Appl. No.: 18/255,495

(22) PCT Filed: Dec. 9, 2021
(86) PCT No.: PCT/EP2021/084946

§ 371 Date: Jun. 1, 2023

(30) Foreign Application Priority Data
Dec. 10, 2020 (EP) 20306535.4
Dec. 15, 2020 (EP) 20306572.7

(51) Int. Cl. G21G 1/10; G21G 1/00

(52) U.S. Cl. CPC G21G 1/10; G21G 1/001; G21G 2001/0089; G21G 2001/0094

(57) ABSTRACT

The invention relates to a method for producing high specific activity radionuclides, comprising the steps of: a) irradiating a target of interest by a particle beam, so as to obtain an irradiated target comprising radionuclides of interest, b) chemically extracting a batch of radionuclides of interest from the irradiated target, c) mass-separating the batch of radionuclides of interest so as to obtain high specific activity radionuclides.

### TECHNICAL FIELD

The invention pertains to the field of the production of high purity and high specific activity radionuclides e.g. for medical use at industrial scale.

### BACKGROUND ART

Radioisotopes, or radionuclides, are widely used in the fields of life science, research and medicine, for example, in nuclear medicine.

In nuclear medicine, they are used in diagnostic imaging and radiotherapy, in particular for cancer diseases. To reach the target, a radioisotope can be attached to a molecule/vector, be injected in a solution (e.g. citrate), or standing alone (Zimmermann, Nuclear Medicine: Radioactivity for Diagnosis and Therapy-2017-EDP Science Edition).

The radionuclides could be bound to a vector by using a chelator and a linker. A chelating agent is a substance which can form several bonds to a single atom or ion, also defined as multidentate ligand. When using a vector, the suitable biological target must be found for clinging the tumor cells while sparing the healthy cells. This is possible using peptides or antibodies that have preferential uptake into specific receptor and by choosing those targeting receptors that are more frequently present in tumor cells rather than in healthy ones. Radioisotopes labelled to the same vector, preferably peptide or antibody, which guarantee imaging and therapy are defined as theranostics (or theragnostic) radioisotopes (Langbein et al: J Nucl Med. 2019 Sep; 60(Suppl 2):13S-19S.

One such important application for radioisotopes is the diagnosis and therapy of diseases, such as cancer. For example, there has been considerable progress during the last two decades in the use of radio-labelled tumor-selective peptides and monoclonal antibodies in the diagnosis and therapy of several types of cancer. The concept of localizing the cytotoxic radionuclide to the cancer cell is an important supplement to conventional forms of radiotherapy. In theory, the interaction of a radiopharmaceutical with a target cell enables the absorbed radiation dose to be concentrated at the cancer cells site minimizing the injury to the normal surrounding cells and tissues (Zhejiang et al. Univ Sci B. 2014 October; 15(10): 845-863; Zukotynski et al. Biomark Cancer. 2016; 8(Suppl 2): 35-38). The selection of the radioisotope is based on the nature of the emitted radiation, its physical properties (i.e. energy, half-life and decay chain) and its chemical properties. On the basis of the emitted radiation, radioisotopes can be subdivided into gamma (γ) ray emitters, beta (positron β+ or electron β−) particles emitters and alpha (a) particles emitters, Auger emitters or their combinations. Further advances in the nuclear medicine field will require investigation of the use of new isotopes, new sources and methods of isotope production.

Three main direct or indirect nuclear processes leading to the production of the intended radioisotopes can defined as radionuclides production method and be identified: Nuclear reactions performed through the use of particle accelerators, as for example cyclotrons, linear and electrons accelerators Nuclear reactions performed within nuclear reactors Production of radioisotopes of choice obtained through chemical elution process inside so-called generators. Furthermore, the production methods might be coupled with other techniques for improving the quality of the product.

Radioisotopes can be produced through nuclide transmutation by bombarding target nuclei with charged particles (mainly protons, deuterons or alpha particles). These charged particles need to be accelerated to energies of at least several MeV in order to overcome the target nucleus Coulomb barrier and enable the nuclear reaction. As a result, a particle accelerator is required. Because of their practical characteristics and high current performance for the entire energy range of interest (10-100 MeV), cyclotrons have been almost exclusively chosen as the most convenient option for radioisotope production since the 1950s, except for some therapeutic radionuclides that are more conveniently produced in nuclear reactors. However, only some radioisotopes can be produced in a cyclotron at high radionuclidic purity and with high yields of production. In order to increase the access to few others nuclides, for example, US 20170169908A1 illustrates the use of a 70 MeV cyclotron with an online mass separation system, meaning simultaneous or quasi simultaneous irradiation of a target with the cyclotron and the separation of the latter with the online mass separator for the production of the radionuclides. However, these methods imply constraints on the target to irradiate which must have determined characteristics which could potentially lower the overall yield (e.g. porosity, evaporation temperature, etc.) and limit the producible radioisotopes with high efficiencies. Another example is U.S. Pat. No. 9,202,600B2 (also CA2594829C and GB2436508B) illustrating the production of radionuclides with high-energy accelerators and the mass separation. The main issue again is the availability of high yield produced radionuclides enabling their industrial application.

### Technical Problem

However, the current used methods in radioisotope production have reached their limits and there is a strong need for new and improved methods for increasing the access to new and currently used isotopes. This applies in particular to the isotopic purity, the yield, the specific activity and the range of available radionuclides.

With the growing diffusion of positron emission tomography (PET)/single photon emission computed tomography (SPECT) imaging and the developments in systemic of radionuclide therapy, there is a growing need for radioisotope preparations with higher radiochemical and radionuclides purity that has not been achieved before, guaranteeing a suitable production yield for industrial commercialization.

Furthermore, an implementation of the break-through in development of the drug target delivery systems of new methods of cancer therapy is limited due to the lack of availability of the existing radionuclides with optimal decay characteristics for such applications. For the Radio Ligand Therapy (RLT) it is essential that the radionuclidic purity is sufficiently high to ensure patient safety and minimize the risk associated to potential harmful contaminants, both in terms of toxicity and in terms of nuclear wastes.

Furthermore, sometimes radionuclides could be produced only in research facilities, where the radionuclide production, especially for medical applications corresponds to a small part of the available time. Therefore, these radionuclides are not routinely available for distribution and use which slows down the potential use of them for example for nuclear medicine application and research. Regarding the increasing demand of specific radionuclides and the difficulties encountered to provide said specific radionuclides with commercial accelerators, it is important to provide a method enabling to optimize the use of said commercial accelerators, especially during dedicated time for medical applications.

This can be achieved by using commercial accelerators and/or nuclear reactors for the production of the wanted radionuclides. However sometimes the purity and the specific activity of the produced radionuclides batches are not high enough for receptor targeted applications. Thus, the produced batches will require additional processes to meet those requirements: e.g.: chemical separation allows to increase the purity of the batch and mass separation allows increasing the radionuclidic purity.

### SUMMARY OF THE INVENTION

It is of the merit of the inventors to have discovered a method coupling a radionuclide production method, chemical extraction and mass separation providing a cost effective, flexible and efficient production for a wide variety of radionuclides in large scale at high radionuclidic purity and specific activity that allows their use for receptor targeted applications.

An object of the present invention is thus to provide a method for producing high purity and high specific activity radionuclides. The specific activity is to be understood as the ratio of the activity of the produced radionuclide upon the total mass of all the nuclides belonging to the same element of the produced radionuclide

### DESCRIPTION OF THE INVENTION

In that respect, it is provided a method for producing high specific activity radionuclides, comprising the steps of:
a) irradiating a target of interest by a particle beam, so as to obtain an irradiated target comprising radionuclides of interest,
b) chemically extracting the radionuclides of interest from the irradiated targets to increase the chemical purity,
c) mass-separating the radionuclides of interest so as to obtain high specific activity radionuclides.
   The particles of the beam may be protons, neutrons, photons, deuterons or alpha particles. As particle beam are preferred proton beam when considering accelerator based production and neutron beam when considering reactor based production. The particles of the beam induce nuclear reactions so as to obtain an irradiated target comprising radionuclides of interest.
   The main objectives of step b) are to increase the batch purity and strongly increase the step c) efficiency by eliminating high fractions of key impurities.

Another object of the present invention consists in high specific activity radionuclides obtainable by a method according to the invention.

Yet another object of the present invention is a medical use of a high specific activity radionuclide according to the invention. The invention relates to a high specific activity radionuclide according to the invention for use in a method for treatment of human or animal body by therapy or in a diagnostic method practiced on human or animal body.

Radionuclides of interest are defined as a known radionuclide, preferably the known radionuclide is an alpha emitter, beta(−) emitter, beta(+) emitter, gamma emitter, Auger emitter. Preferably the known radionuclide belongs to the following list of radionuclides herein: F-18, Sc-43, Sc-44, Sc-47, Cr-51, Mn-52m, Fe-52, Co-55, Cu-61, Cu-62, Cu-64, Ga-66, Cu-67, Ga-67, Ga-68, As-72, As-76, Rb-82, Y-86, Zr-89, Y-90, Ru-97, Tc-99m, Rh-105, In-111, Ag111, Sn-117m, Sn-121, I-123, I-124, I-131, Pr-142, Pr-143, Tb-149, Pm-149, Pm-151, Tb-152, Sm-153, Tb-155, Gd-157, Gd-159, Tb-161, Er-165, Dy-166, Ho-166, Tm-167, Er-169, Yb-169, Tm,-172, Yb-175, Lu-177, Re-186, Re-188, Au-198, Au-199, Pb-203, At-211, Pb-212, Bi-212, Bi-213, Ac-225, Ac-227 and Th-229 preferably selected from Sc-43, Sc-44, Sc-47, Tb-149, Tb-152, Tb-155, Tb-161, Lu-177, other lanthanides and Ac-225.

The present invention enables to produce batches of radionuclides that are difficult to produce or cannot be produced with enough radionuclidic purity by other means. These radionuclides will be produced with high purity and high specific activity allowing a wide variety of applications for example for both imaging and therapy protocols in medical fields. Radionuclides will be available for example for hospitals and research centers for in-vivo and in-vitro studies.

Preferably, the radionuclides of interest would be chosen from radionuclides enabling theranostics treatments. The theranostic approach in nuclear medicine couples diagnostic imaging and therapy using the same molecule or at least very similar molecules, which are either radiolabeled differently or given in different dosages. For example, copper-67, iodine-131 and lutetium-177 are gamma and beta-emitters; thus, these agents can be used for both imaging and therapy. Furthermore, different isotopes of the same element, for example, iodine-123 (gamma emitter) and iodine-131 (gamma and beta emitters), can also be used for theranostic purposes. Newer examples are yttrium-86/yttrium-90 or terbium isotopes (Tb): Tb-152 (beta+ emitter), Tb-155 (gamma emitter), Tb-149 (alpha emitter), and Tb-161 (beta-emitter)) [table 1]. Furthermore, different isotopes of different chemical elements, for example, radiolanthanides such as Lu-177 (gamma and beta emitter for therapy) and radionuclide with similar chemical properties such as Ga-68 (beta+ emitter), can also be used for theranostic purposes.

TABLE 1

| Element | Radionuclide | Application |
|---|---|---|
| Scandium | Sc-43 | PET |
| | Sc-44 | PET |
| | Sc-47 | Therapy |
| Copper | Cu-61 | PET |
| | Cu-64 | Therapy/PET |
| | Cu-67 | Therapy/SPECT |
| Arsenic | As-72 | PET |
| | As-76 | Therapy |
| Terbium | Tb-149 | Therapy/PET |
| | Tb-152 | PET |
| | Tb-155 | SPECT |
| | Tb-161 | Therapy |
| Lutetium | Lu-177 | Therapy |
| Erbium | Er-169 | Therapy |
| Actinium | Ac-225 | Therapy |

Preferably, the high specific activity radionuclides are chosen among the isotopes of terbium. In that case, the target of interest comprises preferably natural or enriched gadolinium, preferably metallic, oxide or chloride, preferably to be irradiated with accelerator proton beam.

Indeed, there is a potential increasing need in the medical industry for isotopes of terbium which is difficult to meet with current means of production. For example, metallic or oxide natural gadolinium could be a good compromise between raw material availability and terbium radionuclides production yield. The chemical separation will mainly involve terbium and gadolinium elements and the mass separation the terbium nuclides.

Preferably, the high specific activity therapeutic radionuclide chosen is erbium Er-169. In that case, the target of interest comprises preferably natural or enriched (in Er-168) erbium, preferably metallic, oxide, nitrate or chloride, preferably to be irradiated in a nuclear reactor with neutrons.

Indeed, there is a potential need in the medical industry for erbium at high specific activity, which is not possible to achieve with current means of production. For example, nitrate or oxide highly enriched Er-168 is a good target material to be considered for achieving high yields of production. The chemical separation will mainly involve ytterbium and erbium elements and the mass separation the erbium nuclides.

Other preferred, high specific activity radionuclide can be chosen among the isotopes of scandium. In that case, the target of interest preferably comprises metallic titanium, more preferably natural metallic titanium which is widely available and allows high scandium radionuclides production yields.

Indeed, there is an increasing need in the medical industry for isotopes of scandium which are difficult to meet with current means of production. Metallic titanium is a good compromise between raw material availability and scandium radionuclides production yield. The chemical separation will mainly involve scandium and titanium elements and the mass separation the scandium nuclides.

The high specific activity radionuclides may also be chosen among the isotopes of actinium, and wherein the target of interest comprises preferably natural thorium.

Indeed, there is an increasing need in the medical industry for isotopes of actinium which are difficult to meet with current means of production. Natural thorium is a good compromise between raw material availability and actinium radionuclides production yield. The chemical separation will mainly involve thorium and actinium elements and the mass separation the actinium nuclides.

The high specific activity radionuclides may also be chosen among the isotopes of lutetium, and wherein the target of interest comprises preferably metallic ytterbium.

Indeed, there is an increasing need in the medical industry for isotopes of lutetium which are difficult to meet with current means of production. Metallic ytterbium is a good compromise between raw material availability and lutetium radionuclides production yield. The chemical separation will mainly involve lutetium and ytterbium elements and the mass separation the lutetium nuclides.

Hereafter are listed the main steps of the invention. The steps might also be performed in a different order or repeated several times to ensure the production of high quality products.

Step a): Target Irradiation

The method for producing high specific activity radionuclides comprises the step a) of irradiating a target of interest by a particle beam, preferably a proton beam, so as to obtain an irradiated target comprising radionuclides of interest. The proton beam of step a) may present an energy comprised between 18 and 200 MeV preferably between 30 and 70 MeV. Such energy offers an interesting compromise between the difficulty to generate such beam and the radionuclides production yield. This proton beam may be provided by a commercial cyclotron, as for example the Arronax IBA C70 cyclotron, located in Nantes, France.

Step b): Chemical Extraction

The method for producing high specific activity radionuclides comprises the step b) of chemically extracting a batch of radionuclides of interest from the irradiated target.

The target of interest in step b may be dissolved into an acid solution.

This dissolution conducts to a solution of the target material and the radionuclides, which is the input for the chemical separation process for the production of specific radionuclides. Preferably, the chemical separation process is chromatography.

The step b) may comprise a step for dissolving the target of interest, for example with an acid solution comprising for example a nitric acid (HNO3). The solution thus obtained may be then passed through a resin.

The step b) may comprise a liquid/liquid extraction.

A liquid/liquid extraction allows a good compromise between cost of the material needed for the chemical separation and the volume of the experimental setup for high target masses separation.

The step b) may also comprise a liquid/solid extraction.

A liquid/solid extraction can be good compromise between cost of the material needed for the chemical separation and the volume of the experimental setup for high target masses separation.

This chemical separation step provides an improvement in the radiochemical purity. Thus, it enhances the efficiency of the step c) mass separation to increase the yields achievable from the invention by eliminating the target material as compared to the desired radionuclide.

The method for producing high specific activity radionuclides according to any embodiments may further comprise a step b2) of target coupling comprising:
pouring the liquid solution obtained in step b) on a support, preferably a metallic support,
heating up and evaporating the liquid solution on the support so as to deposit the radionuclide on the support,
inserting the support comprising the radionuclides of interest into a mass separation system.

If gadolinium is the target of interest, step b) can comprise a step for dissolving metallic gadolinium within an acid solution, preferably comprising nitric acid. The obtained solution can then be passed through resins. This step is more detailed in example 2.

This step allows decreasing the content of gadolinium, which translates in improved efficiencies of the successive mass separation.

In case high specific activity radionuclides are chosen among the isotopes of scandium, step b) can comprise a step for dissolving metallic titanium within an acid solution, preferably hydrobromic acid (HBr) solution. This process might require difference of potential applied to the metal to favor the dissolution, and then dissolving the obtained solution into an acid and passing it through a resin.

This step allows decreasing the content of titanium, which translates in improved efficiencies of the successive mass separation.

Step c): Mass Separation

The contaminants belonging to the same element cannot be separated via chemical separation. Therefore, a physical separation process, preferably mass separation is considered. The step of mass separation enables to get higher specific activity radionuclides and higher radionuclidic purity.

The method for producing high specific activity radionuclides comprises the step c) of mass-separating the batch of radionuclides of interest in order to obtain high specific activity radionuclides, wherein the mass-separation conventionally uses a target oven to evaporate the atoms, a ionizer which ionize the atoms, an extraction electrode to post-accelerate the ions, a magnet which allows the mass separation, and a collection support.

The ionization of the atoms in the mass separation step can be achieved by a conventional ion source. Eventually laser ionization can be considered to improve the ionization efficiency.

Step d) Second Chemical Separation (Optional)

The method for producing high specific activity radionuclides may further comprise a step d) consisting of a second chemical separation and purification occurring after the mass separating step.

This is a non-mandatory step, which will likely not happen due to the very pure product extracted after mass separation. However, it does present an interest whenever there is an interest into defining a compromise between the time needed for a very good first chemical separation before mass separation and the final product. In those cases, the chemical separation can be divided in two steps, a first chemical separation before mass separation, and a second chemical separation after mass separation. Furthermore, it might be needed this second purification depending on how the radionuclides are collected after mass separation. Indeed, different methods to collect the radionuclides can be used. For example, if the radionuclides are deposited onto metallic plates, this second chemical separation step is needed to collect the produced radionuclides.

### BRIEF DESCRIPTION OF DRAWINGS

Other features, details and advantages will be shown in the following detailed description and on the figures, on which:

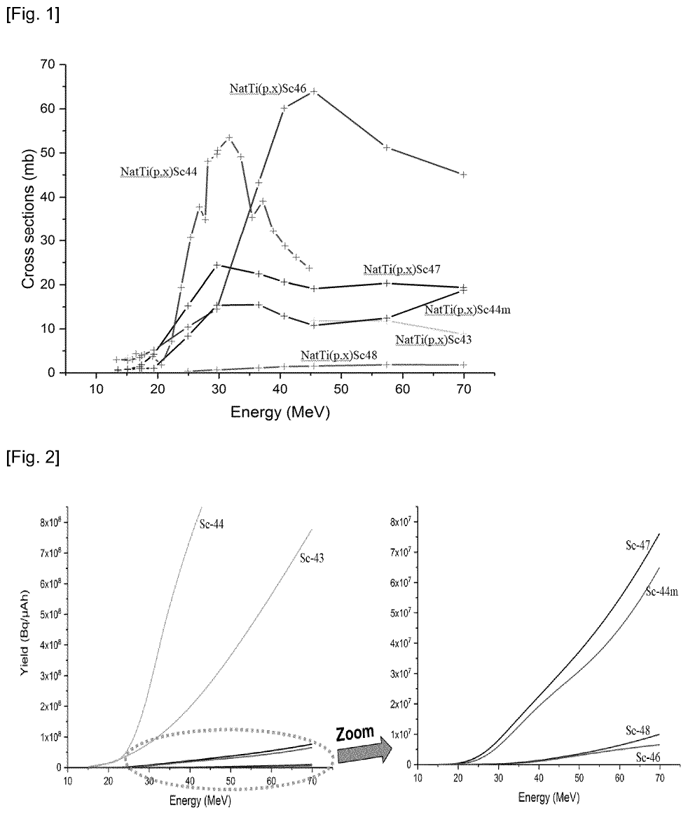

### FIG. 1

FIG. 1 is a flowchart representing the radionuclides which are expected to be generated upon irradiating a natural titanium target, depending on the energy of the irradiating beam;

### FIG. 2

FIG. 2 is a flowchart representing the theoretical scandium yield achievable starting from different targets.

### EXAMPLES

### Example 1

Scandium 47 Production

Preliminary Remarks:

It is of utter importance to determine the best possible departing material.

In case of Scandium-47 production, natural titanium proves to be a good compromise between availability, cost and physical properties, in alternative enriched titanium or enriched calcium can be used too. As shown on FIG. 1, production of Sc-47 out of natural titanium is possible with proton beam energies below 70 MeV. However, other contaminants are co-produced, most importantly the quite long-lived Sc-46 which is not desired when considering Sc-47 for medical applications. This is why appropriate purification and mass separation steps as described in the present invention are mandatory in order to obtain a product usable for medical application e.g. high production yields, high-purity and high specific activity radionuclides.

One should determine the production yield evaluated and shown on FIG. 2.

Table 2 below lists the theoretical calculation of the potential contaminants produced by the irradiation of a natural titanium target. The calculations have been performed with the software MCNPx. Most of the listed contaminants can be removed thanks to chemical separation. Main concern regards Sc-46 which will need complementary separation, for example mass separation. The yield ratio of Sc-46 over Sc-47 is almost 10% at end of bombardment (EOB), which is too high for medical applications, in particular for the RTL applications.

TABLE 2

| | | | Yield EOB | | | | Yield EOB |
|---|---|---|---|---|---|---|---|
| ELEMENT | Half-life | | (Bq/μA/h/g) | ELEMENT | Half-life | | (Bq/μA/h/g) |
| S-35 | 87 | d | 2.06E+03 | K-38 | 7.6 | m | 2.50E+06 |
| Cl-36 | 3E5 | y | 2.79E−02 | K-42 | 12 | h | 1.25E+08 |
| Cl-39 | 56 | m | 6.25E+05 | K-43 | 22 | h | 1.67E+07 |
| Ar-37 | 35 | d | 2.72E+05 | K-44 | 22 | m | 3.13E+06 |
| Ar-39 | 269 | y | 1.73E+02 | Ca-41 | 9.9E4 | y | 7.92E+00 |
| Ar-42 | 33 | y | 1.50E+01 | Ca-45 | 162 | d | 1.47E+06 |
| Ca-47 | 4.5 | d | 8.88E+05 | Sc-48 | 43.7 | h | 8.77E+07 |
| Sc-43 | 3.89 | h | 8.10E+08 | Sc-49 | 57 | m | 2.14E+08 |
| Sc-44 | 3.97 | h | 9.66E+09 | Ti-44 | 60 | y | 1.97E+04 |
| Sc-45m | 318 | ms | 2.78E+01 | Ti-45 | 185 | m | 6.81E+09 |
| Sc-46 | 83.8 | d | 5.48E+07 | V-47 | 32 | m | 3.22E+09 |
| Sc-47 | 3.34 | d | 5.29E+08 | V-48 | 16 | d | 8.66E+07 |

Theoretical estimation can be performed considering one metallic titanium disk having a thickness of 4 mm and a diameter of 26 mm. The metallic disk is submitted to a 70 MeV and 25 μA proton beam for 3 days (3 days corresponds to the Sc-47 half-life).

After the irradiation, a batch of radionuclides of interest is chemically separated and purified from the irradiated target. A differential of potential is applied to the irradiated target to favor the dissolution of the latter in diluted HBr. After that, the acid solution is modified with diluted HNO₃ in order to satisfy the conditions at the entry of the resin. After washing with the appropriate media, the Sc is eluted from the resin. The eluted solution will have a strongly reduced titanium content compared to the initial solution. This allows reducing the high amount of Ti-47 which cannot be separated during the mass separation step. This drawback may be overcome using laser ionization.

The specific activity per unit target mass is at this point of the process 65,8 MBq/mg.

Then, the batch of radionuclides is separated according to a mass separation process, wherein the atoms and eventually molecules having mass 47 can be selectively extracted and recovered on a dedicated foils, as for example a Zn coated gold support, which undergo chemical process to recover Sc-47 from the material of the foil.

The specific activity per unit target mass is at end of the process according to the invention around 2,8×10³ GBq/mg close to the maximum theoretical specific activity which is 3,08×10⁴ GBq/mg.

A further chemical separation might be foreseen after the mass separation to remove the residual titanium content from the produced radionuclide batch in order to further increase the radiochemical purity.

### Example 2

For the Tb-155 production (this applies also for the two other Tb radionuclides, such as Tb-149 and Tb-152), three metallic gadolinium foils (25 μm thick) purchased from Goodfellow were used as targets. They were irradiated at the Arronax cyclotron for 12 h at 30 μA using protons of 55 MeV. This latter energy is chosen to get 33 MeV on target based on our target design). The Tb-155/Gd ratio at EOB was 1:2.7E6. The main radioactive contaminants are presented in the table below:

| | Expected activity EOB |
|---|---|
| Radionuclide | (MBq) |
| Tb-155 | 774 |
| Tb-153 | 1568 |
| Tb-156 | 328 |
| Tb-154 | 3929 |
| Gd-159 | 1076 |

After irradiation, the 3 targets are dismounted from the target holder.

The chemical process is made of 2 chromatographic columns filled of Ln resin (column 1 (500 mm, V=36.9 mL) and column 2 (250 mm, V=8.6 mL)). All elutions are made at 1 mL/mn using a high-pressure pump.

The Gd foils are dissolved in concentrated nitric acid (2 M) and then evaporated to dryness. The dry residue was recovered in 3 mL of diluted nitric acid (0.75 M) and loaded onto column 1 previously washed to remove impurities and prepared with HNO₃ 0.75 M. In these conditions, gadolinium is less restrained by the column than Tb allowing to remove a large part of it by washing the column using 40 mL of HNO₃ followed by 80 mL of HNO₃ 1.M. The terbium element was then eluted using 45 mL of HNO₃ 1 M followed by 40 mL of HNO₃ 2 M. The 85 mL are then evaporated to dryness and recovered in 3 mL HNO₃ 0.75 M for a second purification step using column 2. The solution is poured on column 2, traces of Gd are eluted using 12 mL HNO₃ 0.75 M followed by 15 mL of HNO₃ 1.M. Tb is then recovered using 10 mL of HNO₃ 1.M followed by 15 mL of HNO₃ 2 M. These 25 mL are evaporated to dryness.

After cooling, the residue is recovered in 3 mL of 0.01 M HNO₃. The obtained terbium solution was then poured onto a tantalum boat covered with rhenium suitable for the mass separation target system, in particular to the CERN-MEDICIS target system as it was the one considered in this example. Then the sample was heated up to evaporate the acid and obtain the terbium residue deposited on the rhenium support. The tantalum boat is then shipped to CERN and inserted in CERN-MEDICIS target for mass separation. At the end of the these chemical steps, the ratio Tb155:Gd is below 1:20, very high improvement from EOB ratio.

The target system was installed at CERN MEDICIS, and the mass separator was setup for the terbium extraction. The target has been heated up to 600 A to allow optimization of the laser on mass 159. A laser on/off ratio of 620/110 pA has been measured. The target has been heated up to 700 A and the einzel optimised at 22.3 kV. A primary current of (FC70) 726 nA has been measured. The separated current was 241 pA laser on and 245 pA laser off. On the sample, 194 pA were measured with 5.8 pA on the collimator. The target has been heated to 750 A, giving a current on the sample of 600 pA (3.8 pA on the collimator). The maximum current measured on the sample was 900 pA (collimator 3 pA). The collection time was of 22 hours.

The target loaded on the separator had an activity of 230 MBq and the collected Tb-155 was 2.9 MBq corresponding to an overall efficiency of 1.3% with a radionuclidic purity higher than 99.9%

A further chemical purification is needed to extract the Tb-155 atoms from the implantation zinc-coated gold foil.

### Example 3

A natural Er-203 target was irradiated with a proton beam of 72 MeV to produce Tm-165, 167 and 168 radionuclides. The target with a total of 150 MBq activity was transferred in a Target and Ion Source Unit and coupled to the MEDICIS Target Station; the isotope mass separation took place over 4 days at mass 167, at a beam energy of 60 kV with a ion source temperature between 2100 and 2190° C., and a target that was steadily increased over the 4 days from 1760° C. to 2300° C. The total ion beam current was comprised between 14 nA and 8uA. The measured beam intensity during collection at A=167 varied between 53 pA and 118 nA, with a gaussian beam profile of sigma H1.0 mm×V0.74 mm. The separated activity was collected over 3 metallic foils and distributed partly in the chamber. The starting Tm-167 activity in the target before separation was 77 MBq, and the recorded separated activity of 42 MBq at End of Collection; this provides a separation efficiency of 54%. The radionuclidic purity was assessed by high purity Germanium detector and found to be better than 99.99%, with Tm-165 and Tm-168 contaminants activities below the detection threshold.

### CONCLUSION

It has been shown in these examples that radionuclide of interest with high specific activity, high purity and potentially high yields can be obtained thanks to the method of the invention. The example also shows how the chemical separation before mass separation improves the efficiency of the latter, and how the mass separation step is important in order to enhance radionuclidic purity.

1-16. (canceled)

17. Method for producing high specific activity radionuclides, comprising the steps of:
a) irradiating a target of interest by a particle beam, so as to obtain an irradiated target comprising radionuclides of interest,
b) chemically extracting the radionuclides of interest from the irradiated target
c) mass-separating the batch of radionuclides of interest so as to obtain high specific activity radionuclides.

18. Method for producing high specific activity radionuclides according to claim 17, wherein the particle beam of step a) is a proton beam presenting an energy comprised between 18 and 200 MeV.

19. Method for producing high specific activity radionuclides according to claim 17, wherein step b) comprises dissolving the target of interest into an acid solution.

20. Method for producing high specific activity radionuclides according to claim 17, wherein the high specific activity radionuclides are chosen among the isotopes of terbium, and wherein the target of interest comprises metallic gadolinium.

21. Method for producing high specific activity radionuclides according to claim 20, wherein step b) comprises dissolving metallic gadolinium within a nitric acid solution and passing the obtained solution through a resin.

22. Method for producing high specific activity radionuclides according to claim 17, wherein the high specific activity radionuclides are chosen among the isotopes of scandium, and wherein the target of interest comprises metallic titanium.

23. Method for producing high specific activity radionuclides according to claim 22, wherein step b) comprises exposing metallic titanium to an HBr solution while submitting it to a voltage, dissolving the solution into an acid and passing the obtained solution through a resin.

24. Method for producing high specific activity radionuclides according to claim 17, wherein step b) comprises a liquid/liquid extraction.

25. Method for producing high specific activity radionuclides according to claim 1, wherein step b) comprises a liquid/solid extraction.

26. Method for producing high specific activity radionuclides according to claim 17, wherein the high specific activity radionuclides are chosen among the isotopes of actinium, and wherein the target of interest comprises natural thorium.

27. Method for producing high specific activity radionuclides according to claim 17, wherein the high specific activity radionuclides are chosen among the isotopes of erbium, and wherein the target of interest comprises natural erbium.

28. Method for producing high specific activity radionuclides according to claim 17, wherein the high specific activity radionuclides are chosen among the isotopes of lutetium, and wherein the target of interest comprises metallic ytterbium.

29. Method for producing high specific activity radionuclides according to claim 17, further comprising a step b2) of target coupling comprising:
pouring a liquid solution obtained in step b) on a support,
heating up and evaporating the liquid solution on the support so as to deposit the radionuclide on the support,
inserting the support comprising the radionuclides of interest into a mass separator.

30. Method for producing high specific activity radionuclides according to claim 17, further comprising a step d2) of a second chemical separation and purification after the mass separating step.

31. High specific activity radionuclides obtainable by a method according to claim 17.

32. A method for treating or diagnosing a human or animal body comprising administering a high specific activity radionuclide according to claim 31 to said human or animal body in need thereof.
